(19) United States
(12) Patent Application Publication
(10) Pub. No.: US 2004/0243937 A1
(43) Pub. Date: Dec. 2, 2004

(54) Print job management device

(75) Inventors: Kazuhito Gassho, Nagano-ken (JP); Noriyuki Nagai, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/715,835

(22) Filed: Nov. 19, 2003

(30) Foreign Application Priority Data
Nov. 21, 2002 (JP) 2002-337458(P)

(51) Int. Cl. G06F 17/00

(52) U.S. Cl. 715/526

(57) ABSTRACT

The object of the present invention is to facilitate making decisions on printability in a printer.

In a print system, a print server 100, a printer 200, and clients PC1 through PC4 are connected via a network. The print server 100 collects attribute information that is attached to every page of original print data from a client to generate inclusive attribute information, and transmits the inclusive attribute information to the printer 200. The inclusive attribute information is an aggregation of print conditions for respective pages, such as the paper and the resolution for printing. The printer 200 makes a decision on printability of a print job based on the inclusive attribute information and responds a result of the decision to the print server 100. In this way, the decision on printability can be made easily without actually executing the print job, only by transmitting the inclusive attribute information of a relatively small size.

### BACKGROUND OF THE INVENTION

1. Field of the Invention

The present invention relates to a method of managing print jobs, and more particularly, to a handling of attribute information that are included in the print jobs.

2. Description of the Related Art

Recently, because of growing diffusion of LAN (local area network), a printer is often connected to a network and is shared among a plurality of computers that are also connected to the network (hereinafter referred to as “the client computers”). Each of the client computers transmits a plurality of print jobs to the printer. In order to control these print processes, a print server is built-in the printer or is provided separately from the printer. In the print server, the print jobs are managed according to statuses that are defined under International Standards ISO/IEC10175-1 (hereinafter simply referred to as “the International Standards”).

A print job includes various pieces of attribute information for defining print conditions. In case of printing a document of plural pages, an application software typically generates data of the print job by one page at a time from the beginning of the document. Accordingly, the pieces of attribute information for defining the print conditions of the respective pages are dispersed in the print job, on e.g. start locations of the print data for the respective pages.

In a conventional print job, its printability becomes apparent only after the printer starts executing the print job. By way of example, for a print job that includes different printing paper sizes, specified paper size and printability of each page become apparent only after the printer starts processing each page and reads attribute information of each page. If the print job turns out to be unprintable in the middle of the process, a user then needs to change settings of the printer or select another printer, both of which results in inconvenience.

### SUMMARY OF THE INVENTION

The object of the present invention is to solve the above-mentioned problem and to improve convenience in a print system by effectively utilizing attribute information of print jobs.

In the present invention, at least a part of the above object is realized by providing a print job management device that manages print jobs. The print job management device of the present invention inputs a print job, which includes pieces of attribute information being dispersed in plural locations. For a print job that includes plural pages, for example, attribute information may be dispersed and attached to every page break. The print job management device extracts the attribute information from the print job and generates inclusive attribute information that contains the attribute information. The attribute information that originally existed in the print job may be deleted or may be remained without change. In this manner, the inclusive attribute information can be analyzed to obtain the settings or the like that are necessary to execute the print job, which allows for the use of the inclusive attribute information to improve the convenience in printing. For example, a printer that is executable of the print job may be specified by the print job management device, or the settings of the printer may be changed to be executable of the print job.

In the present invention, the inclusive attribute information can be generated as data that is separable from the print job. In this way, the inclusive attribute information can be output to the printer separately from the print job, for example, so that the printer can make a decision on printability only with a small amount of communication. The separable data is not necessarily be configured as a file other than the print job, but may also be configured as a print job that includes the inclusive attribute information and the print contents in a distinctly separated manner.

The inclusive attribute information may also be attached to a header of the print job. This excludes the need of managing correspondence between the inclusive attribute information and the print job, and advantageously allows for an easier handling thereof.

In most cases, the print job management device manages print jobs by coordinating them with predetermined statuses. Since the settings or the like of the printer are configured prior to the printing, some of the statuses may require an analysis of print job contents. From the viewpoint of improving processing efficiency, it is preferable that, in such a case, the print job management device executes an extraction of attribute information in conjunction with an analysis of the same.

The present invention may also be configured as a print device that receives and executes print jobs from the print job management device described above. The print device of the present invention functions to input and analyze inclusive attribute information and to operate according to the inclusive attribute information. For example, in case where a print job includes print contents of plural pages and inclusive attribute information contains print conditions of the respective pages, the print device may be able to set the print conditions of the respective pages based on the inclusive attribute information. The print device may also make a decision on printability based on the inclusive attribute information and output a result of the decision. With such a function of utilizing the inclusive attribute information, it is possible to improve convenience in a print system that is comprised of the print job management device and the print device.

In addition to the print job management device and the print device described above, the present invention can also take various aspects of configuration such as: a method of managing print jobs, a method of controlling a print device, a program for executing these functions, and a recording medium that is recorded with the program. Available examples of the recording medium include flexible disks, CD-ROMs, magneto-optical disks, IC cards, ROM cartridges, punched cards, prints with barcodes or other codes printed thereon, internal storage devices (memories, such as a RAM or a ROM) and external storage devices of the computer, and a variety of other computer readable media.

### BRIEF DESCRIPTION OF THE DRAWINGS

FIG. 1 is a schematic that shows a print data structure in an embodiment.

FIG. 2 is a schematic that shows a print system configuration as an embodiment.

FIG. 3 is an overview of statuses that are defined under the International Standards.

FIG. 4 is a flowchart of a print process.

### DESCRIPTION OF THE PREFERRED EMBODIMENTS

Preferred embodiments of the present invention are described below in the following order.

A. Print Processing Overview:

B. System Configuration:

C. Print Process:

D. Modifications:

### A. Print Processing Overview

The present embodiment illustrates a print system in which clients, a print server, and a printer are connected via a network. As a print job, the client issues to the print server original print data that contains attribute information. The print server manages the print job, gathers the attribute information into inclusive attribute information, transmits the inclusive attribute information to the printer as required, and then executes a print process.

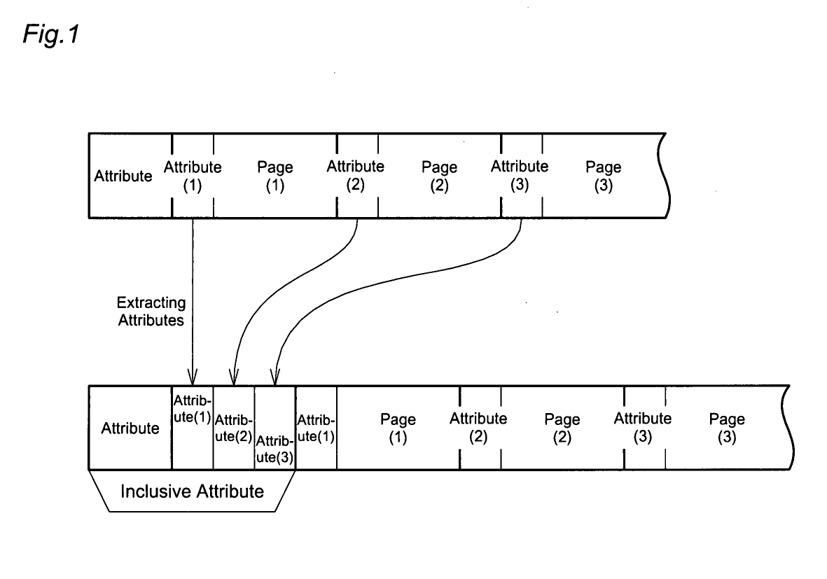

FIG. 1 is a schematic that shows a print data structure in an embodiment. Upper half of FIG. 1 shows a structure of original print data that is issued from a client. The original print data is data for printing a document of plural pages, and not only a header area of the data is attached with attribute information that indicates print conditions, but also the beginning of each page is attached with attribute information that corresponds to each page. The attribute information is recorded with print conditions such as the size and type of paper for printing and the resolution of printing.

Lower half of FIG. 1 shows print data that has been processed by the print server. When input with original print data, the print server extracts attribute information included therein and generates inclusive attribute information that contains the entire attribute information. The attribute information that is attached to each page may be deleted in this process, although remains without change in the present embodiment. In this way, the non-inclusive attribute information part of the data can remain interchangeable with the original print data.

### B. System Configuration

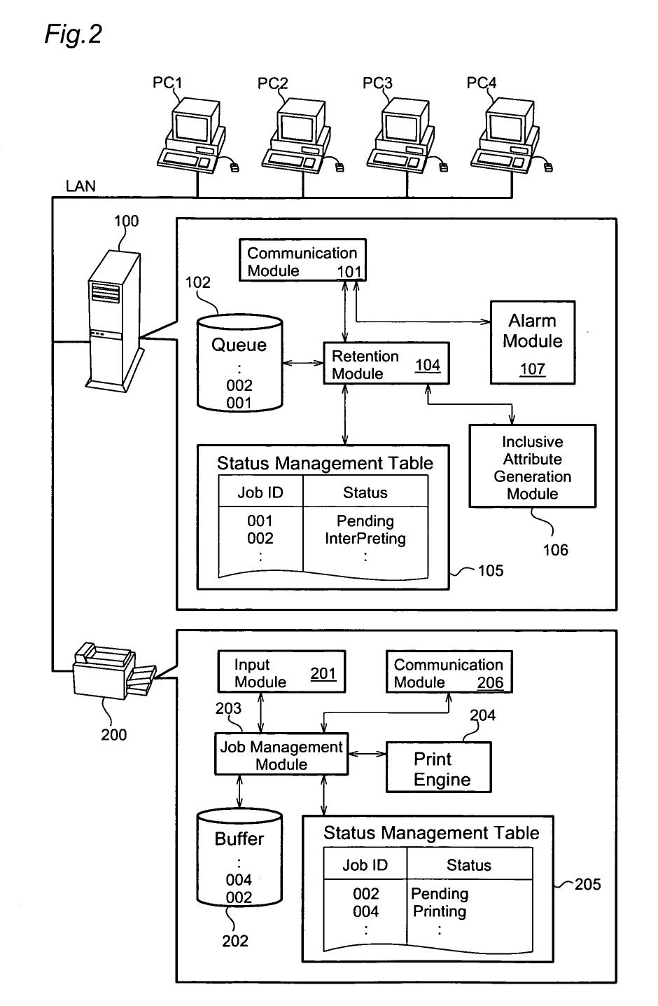

FIG. 2 is a schematic that shows a print system configuration as an embodiment. Client computers PC1 through PC4, a print server 100, and a printer 200 are connected via LAN (Local Area Network). The print server 100 functions as a print job management device that manages statuses of print jobs. Although the print server 100 is separate from the printer 200 in the present embodiment, the print server 100 may also be integrated with the printer 200. In addition, numbers of the client computers and the printer are not restricted to those illustrated in FIG. 2.

The client computers PC1 through PC4 are general-purpose computers that are capable of using varieties of applications to create documents and images. To execute printing, the client computers PC1 through PC4 transmit print jobs, which contain data of these documents and images, to the print server 100. The print jobs are packetized according to a predetermined communication protocol and are transmitted to the print server 100 via LAN. The print server 100 incorporates a queue 102 for spooling that temporarily stores the received print jobs. The print server 100 manages statuses of the plural print jobs that are received from the client computers PC1 through PC4 and executes printing in a successive way.

FIG. 2 shows functional blocks that function as a print job management device in the print server 100. Each of the functional blocks except for the queue 102 is configured by software by installing a computer program for print job management into the print server 100.

A communication module 101 functions to communicate between the client computers PC1 through PC4 and the printer 200 via the network. An alarm module 107 communicates with the printer 200 to make decisions on printability of the print jobs, and if any of the print jobs is unprintable, alarms the client or the issuer of the print job.

A retention module 104 stores or deletes the print jobs into or from the queue 102, updates the statuses of the print jobs, transmits the print jobs out of the queue 102, and so on. A status management table 105 is a table to which the retention module 104 makes reference to, and coordinates and stores job IDs and statuses that are granted to the respective print jobs. In the present embodiment, the statuses are managed according to the International Standards. An inclusive attribute generation module 106 generates inclusive attribute information, which is an aggregation of the attribute information included in the original print data, in a mode shown in FIG. 1.

FIG. 2 also shows functional blocks of the printer 200. The printer 200 has a control unit that is comprised of a microcomputer including a CPU, a ROM, and a RAM. Each of the functional blocks shown in FIG. 2 except for a buffer 202 is configured by software within the control unit.

An input module 201 receives a print job from the print server 100. The received print job is temporarily stored in a buffer 202 for spooling. A print job management module 203 stores or deletes the print job into or from the buffer 202, transmits the print job from the buffer 202 to a print engine 204, and manages a status of the print job. The status of the print job is coordinated with a job ID and is stored in a status management table 205. The print job management module 203 makes a decision on printability of the print job based on inclusive attribute information that is received from the print server 200, and notifies a result of the decision to the print server via a notification module 206. In case where the print job is decided to be printable, the print job management module 203 controls the print engine 204 so as to set the printing paper and the printing resolution to those specified in the inclusive attribute information, and then executes printing.

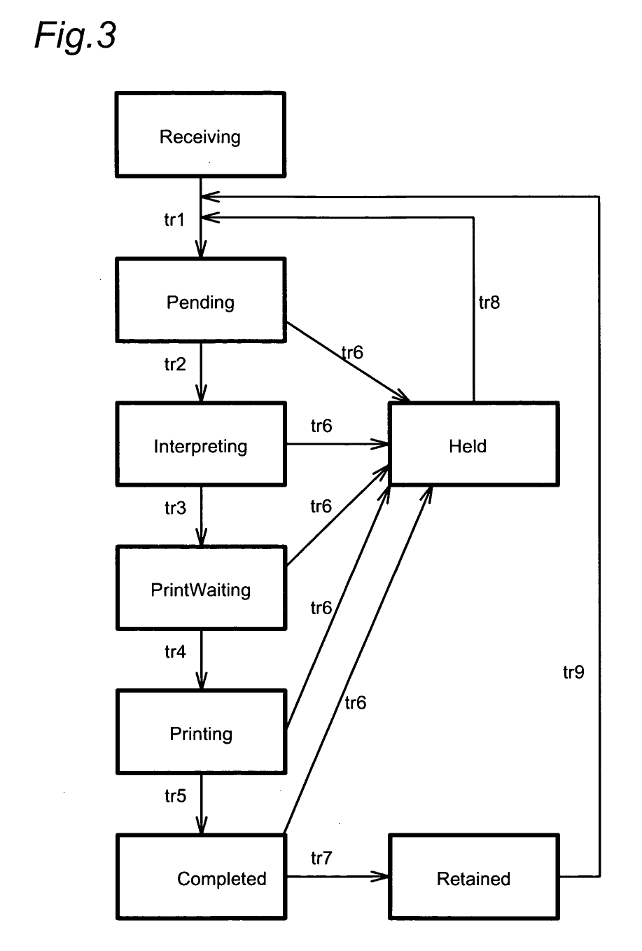

FIG. 3 is an overview of statuses that are defined under the International Standards. In the print server 100 and the printer 200, the status of each print job is managed according to the International Standards.

The status of the print job shifts from “Receiving” to “Pending” when the print job is received (arrow tr1). The print job in the “pending” status is updated into “interPreting” status when it's turn for printing comes (arrow tr2). The print job in the “interPreting” status is updated into “printWaiting” status when the interpretation is executed and completed (arrow tr3). The print job in the “pringWaiting” status is updated into “Printing” status when the printing becomes possible (arrow tr4). The print job in the “printing” status is updated into “completed” status when the printing is completed (arrow tr5). The print job may sometimes be attached with an instruction to retain the status for a period of time after the printing. In such a case, the print job shifts from “completed” to “retained” (refer to arrow tr7). The print job in the “retained” status is retained undeleted until an instruction of reprinting is input by a user or a predetermined period of time is passed. In case where the instruction of reprinting is input by a user via an interface such as a client or a printer, the print job in the “retained” status shifts to the “pending” status again (arrow tr9).

In addition to a series of statuses described above, a “held” status is also provided to hold the print job unexecuted. The shift to the “held” status is conducted in response to an instruction from a user via an interface such as a client or a printer. The shift can also originate from other statuses such as “pending”, “interPreting”, “printWaiting”, and “completed” (refer to arrow tr6). The shift to the “held” status may also be conducted by attaching shift-instructing data to the print job. The print job in the “held” status is held in its status until an instruction is received from a user. In response to a release instruction from a user, the print job shifts to the “pending” status again (refer to arrow tr8). The print job in the “held” status may also be instructed a disposal.

### C. Print Process

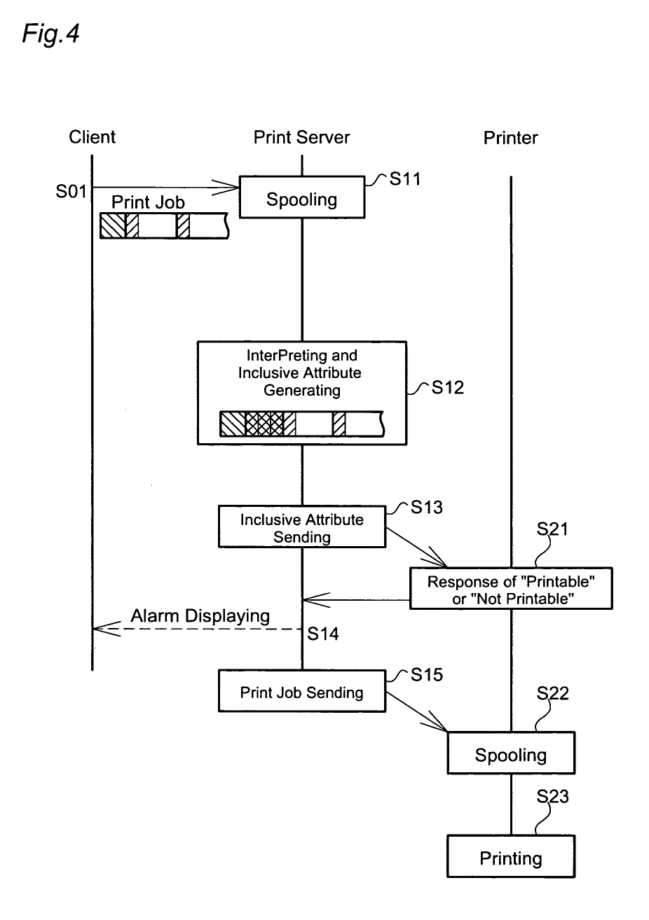

FIG. 4 is a flowchart of a print process. A process in a client computer, a process in the print server 100, and a process in the printer 200 are shown on the left side, the center, and the right side of FIG. 4, respectively. The print server receives a print job from one of the client computer PC1 through PC4 in step S01. As the print job, a structure of original print data (which is a miniature of the original print data shown in FIG. 1) is shown. Areas with hatchings correspond to attribute information, whereas areas only with outlines represent print contents of respective pages.

The print server 100 spools the received print job in step S11, and manages the print job by attaching a status according to the International Standards. In the “interPreting” status, the print server 100 analyzes contents of the print job, extracts attribute information, and generates inclusive attribute information in this order in step S12. FIG. 4 also shows another mode of the data structure that has the inclusive attribute information being attached to its header part. Since the inclusive attribute information is collected on the header part of the data, the inclusive attribute information can be separated and transmitted to the printer 200 by itself. The print server 100 transmits only the inclusive attribute information to the printer 200 in step S13.

Since the inclusive attribute information is recorded with settings for executing the print job, the printer 200 can make a decision on printability based on the inclusive attribute information. The printer 200 responds a result of the decision to the print server 100 in step S21.

The print server 100 executes a process according to the response. In case where the printer 200 responds with not-printable, the print server 100 gives an alarm of not-printable to the client in step S14, as shown by a dashed line.

In case where the printer 200 responds with printable, the print server 100 transmits the print job to the printer 200 in step S15. The printer 200 spools the print job into the buffer in step S22, and then in step 23, sets the paper, the resolution, or the like for printing based on designations in the inclusive attribute information and then executes printing.

According to the print system of the present embodiment described above, the inclusive attribute information is generated in the print server 100, so that the decision on printability can be made easily prior to the execution of the print job. Since not the entire print job but only the inclusive attribute information is transmitted to the printer 200 for the decision of printability in the present embodiment, the amount of data required for the decision can be reduced, too.

### D. Modifications

The above embodiment illustrates a case where the printer 200 makes the decision on printability. Information regarding printability such as the paper and the resolution available in the printer 200, however, may also be managed by the print server 100, so that the print server 100 can make the decision on printability or select a printer to which the print job is transmitted. Even in this case, the inclusive attribute information can still be utilized effectively to make the settings of the printer 200 at the time of printing.

Although the inclusive attribute information is attached to the header area of the print job in the present embodiment, the information may also be generated as a file other than the print job.

The present embodiment illustrates a case where the print server 100 unconditionally generates the inclusive attribute information. The inclusive attribute information, however, may also be generated at the request of the printer 200.

Although various embodiments of the present invention are described above, it is clearly understood that the present invention is not restricted to these embodiments, but there may be various configurations without departing from the spirit of the present invention. For example, the above-described control processing that is realized by software may also be realized by hardware.

What is claimed is:

1. A print job management device that manages print jobs, comprising:
an input module that inputs a print job in which pieces of attribute information are dispersed in plural locations; and
a generation module that extracts said attribute information from said print job and generates inclusive attribute information that contains said attribute information.

2. A print job management device according to claim 1, wherein
said generation module further generates said inclusive attribute information as data that is separable from said print job.

3. A print job management device according to claim 1, wherein
said generation module further attaches said inclusive attribute information to a header of said print job.

4. A print job management device according to claim 1, further comprising:
a status management module that manages said print job in coordination with a predetermined status;
wherein if said print job is in a status of contents analysis, said generation module performs said extraction in conjunction with said analysis.

5. A print device, comprising:
an input module that inputs a cluster of inclusive attribute information that contains pieces of attribute information dispersed in a print job; and
an attribute interpretation module that interprets said inclusive attribute information and operates based on said inclusive attribute information.

6. A print device according to claim 5, wherein
said print job contains print contents of plural pages;
said inclusive attribute information contains print conditions for respective pages of said print job; and
said attribute interpretation module sets the print conditions of the respective pages based on said inclusive attribute information.

7. A print device according to claim 5, wherein
said inclusive attribute information contains print conditions of said print job; and
said attribute interpretation module includes a printability output module that makes a decision on printability based on said inclusive attribute information and outputs a result of the decision.

8. A print job management method that uses a computer to manage print jobs, comprising:
inputting a print job in which pieces of attribute information are dispersed in plural locations; and
extracting said attribute information from said print job and generating inclusive attribute information that contains said attribute information.

9. A method of controlling a print device, comprising:
inputting a cluster of inclusive attribute information that contains pieces of attribute information dispersed in a print job; and
interpreting said inclusive attribute information and controlling said print device to operate based on said inclusive attribute information.

10. A recording medium that is recorded with a computer program for managing print jobs, comprising:
a program code that inputs a print job in which pieces of attribute information are dispersed in plural locations; and
a program code that extracts said attribute information from said print job and generates inclusive attribute information that contains said attribute information.

11. A recording medium that is recorded with a computer program for controlling a print device, comprising:
a program code that inputs a cluster of inclusive attribute information that contains pieces of attribute information dispersed in a print job; and
a program code that interprets said inclusive attribute information and controls said print device to operate based on said inclusive attribute information.
